(19) United States
(12) Patent Application Publication
(10) Pub. No.: US 2020/0019740 A1
(43) Pub. Date: Jan. 16, 2020

(54) AN OWNER-CONTROLLED CARRIER OF VALUE, A PAYMENT INFRASTRUCTURE AND METHOD FOR OPERATING THIS INFRASTRUCTURE

(71) Applicant: ORELL FÜSSLI SICHERHEITSDRUCK AG, Zürich (CH)

(72) Inventors: Dieter SAUTER, Zürich (CH); Sylvain CHOSSON, Zürich (CH); Martin EICHENBERGER, Zollikon (CH)

(73) Assignee: ORELL FÜSSLI SICHERHEITSDRUCK AG, Zürich (CH)

(21) Appl. No.: 16/491,383

(22) PCT Filed: Mar. 6, 2017
(86) PCT No.: PCT/CH2017/000022

§ 371 Date: Sep. 5, 2019

(51) Int. Cl. G06K 7/10; B42D 25/29; G06K 19/06; G06K 7/14

(52) U.S. Cl. CPC G06K 7/10366; B42D 25/29; B42D 25/378; G06K 7/1417; G06K 19/06037

(57) ABSTRACT

The carrier for representing a monetary value as a means of payment comprises a substrate, a control unit mounted to the substrate, a value store for storing a carrier value of the carrier. and an interface circuit for electronic communication of an external device with the control unit. The carrier further comprises an owner store for storing the current owner of the earner. the current owner can e.g. be displayed on a display device of the carrier, or it can be used for restricting certain privileged operations on the carrier to its current owner. A large number of such carriers is used in a payment infrastructure having a plurality of terminal devices that are able to communicate with the carriers through their interface circuits, The infrastructure further comprises a central server device, Values can be transferred to and/or from individual carriers by various methods. A number of measures are described to protect the carriers and the rest of the infrastructure horn tampering.

### TECHNICAL FIELD

The invention relates to a carrier for representing a monetary value, a payment infrastructure and method for operating this infrastructure.

### BACKGROUND ART

There are various types of carriers representing a monetary value, Typical examples are banknotes or prepaid cards (gift cards).

These conventional means of payment provide little versatility and limited security.

### DISCLOSURE OF THE INVENTION

The problem to be solved by the present invention is to provide a carrier for representing a monetary value, a payment infrastructure and method for operating this infrastructure that are more versatile than known solutions while having the potential of good security.

This problem is solved by the carrier, the payment infrastructure and the method of the independent claims.

Accordingly, the invention relates to a carrier for representing a monetary value as a means of payment. This carrier comprises:
A substrate: This substrate is used for physically handling the carrier. The following components are advantageously attached to or built into the substrate.
A control unit: The control unit comprises circuitry for operating the carrier. It is mounted to the substrate.
A value store: This is a memory circuit adapted and structured to store a “carrier value” of the carrier.
An interface circuit: This circuit is designed for allowing an external device to carry out electronic communication with the control unit.
An owner store: This is a memory circuit adapted and structured to store a unique owner identifier assigned to the owner of the carrier.

The presence of such an owner store allows to assign the carrier to an owner, which provides a number of ways to increase the security of the payment system. For example, the owner can be displayed on a display device of the carrier or certain privileged operations can be restricted to the owner.

The invention also relates to a payment infrastructure comprising:
A plurality of the carriers mentioned above.
A plurality of terminal devices: These terminal devices are adapted and structured to communicate with the carriers through said interface circuits. Hence, the terminal devices are at least able to change the values stored in the carriers. The terminal devices can e.g. include smartphones and other mobile devices, ATM machines, and POS machines.

The invention further relates to a method for operating this payment infrastructure. This method comprises the step of establishing a communication between one of the terminal devices and one of said carriers, e.g. using a challenge-response scheme.

The invention also relates to a computer program product comprising instructions that, when the program is executed on this infrastructure, cause the infrastructure to carry out the steps of the method above.

Some of the advantageous aspects of the invention are mentioned in the dependent claims. A number of measures are described to protect the carriers and the infrastructure from tampering.

### BRIEF DESCRIPTION OF THE DRAWINGS

The invention will be better understood and objects other than those set forth above will become apparent when consideration is given to the following detailed description thereof. This description makes reference to the annexed drawings, wherein:

FIG. 1 shows a first embodiment of a carrier,

FIG. 2 is a block diagram of the components of a carrier,

FIG. 3 shows a second embodiment of a carrier,

FIG. 4 is a sectional view of a first embodiment of a display of a carrier,

FIG. 5 is a sectional view of a second embodiment of a display of a carrier,

FIG. 6 is a sectional view of a third embodiment of a display of a carrier,

FIG. 7 is a sectional view of a fourth embodiment of a display of a carrier,

FIG. 8 is a sectional view of a third embodiment of a carrier,

FIG. 9 is the carrier of FIG. 8 in folded configuration,

FIG. 10 is a view of a fourth embodiment of a carrier with a movable authentication device in a first position,

FIG. 11 is the carrier of FIG. 10 with its authentication device in a second position, and

FIG. 12 is a block diagram of a payment infrastructure.

### MODES FOR CARRYING OUT THE INVENTION

Definitions:

An “optically variable device” is a device that changes its visual appearance depending on a viewer's viewing angle. Advantageous examples of optically variable devices comprise diffractive structures, such as surface or volume holograms, raised, repetitive structures, as well as marks printed with optically variable inks.

An “window or half-window” is a region of the carrier's substrate where the substrate has higher transparency or translucency than elsewhere, advantageously a region having an optical transmission of at least 33%, in particular of at least 50%. A “half-window” is a window that does not go all the way through the substrate, i.e. that comprises at least one transparent layer backed by a less transparent or opaque layer.

Carrier:

FIG. 1 shows a first embodiment of a carrier 2. It comprises a substrate 4, which can e.g. be of a flexible or rigid plastic, of paper, or of a combination of such materials.

In the advantageous embodiment shown, substrate 1 is a plastic carrier similar to the one used for credit cards. However, it can e.g. also be a flexible, reversibly foldable substrate, such as it is e.g. used for banknotes.

Substrate 4 can carry printed markings, such as artwork 6 or a serial number 7, on one or both surfaces. These elements e.g. provide information on the (default) currency the carrier represents, the country of origin, etc., and they can comprise known security features, such as optically variable inks, optically variable devices, infrared dyes, fluorescent dyes, etc.

Further, carrier 2 comprises a display device 8 mounted to or integrated into substrate 4. Display device 8 can e.g. be a pixel-based device adapted and structured to display variable, complex artwork, or it can have a simpler geometry, such as it is e.g. used in seven-segment displays, or it can just comprise a small number, such as one, two or three, areas that can be set to an on- or off-state.

Display device 8 is driven by a control unit 10, which is in turn connected to a rechargeable battery 12 and an antenna 14.

Further, substrate 4 advantageously carries, on at least one of its sides, a visually detectable mark 16 encoding an identifier and/or other information. In the embodiment shown, mark 16 is a QR-code, even though it could also be a barcode or a non-standard machine-readable code.

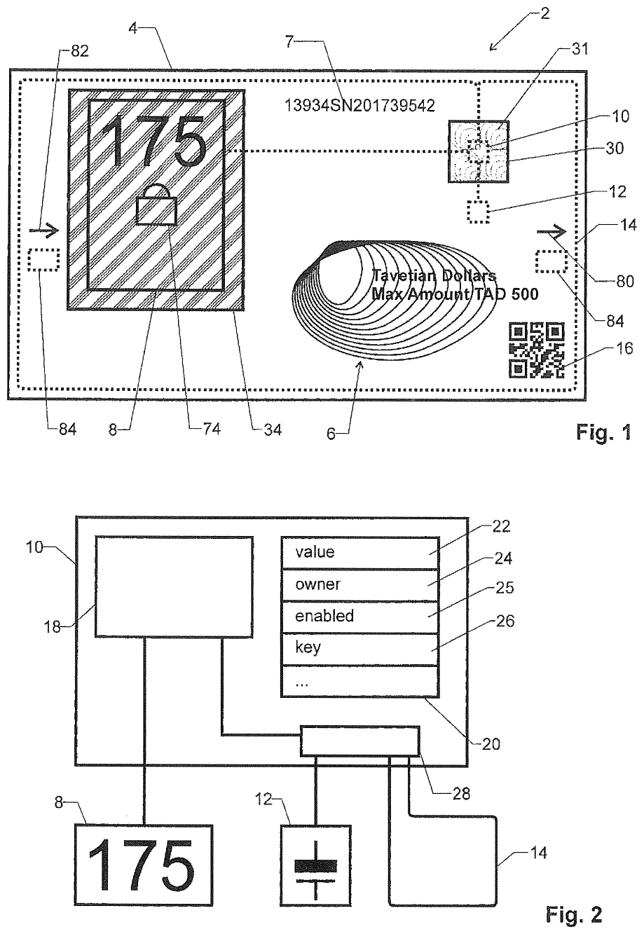

FIG. 2 shows a block circuit diagram of the electronic components of carrier 2.

As can be seen, control unit 10 comprises a processing unit 18, such as a low-power microprocessor, microcontroller or sequential gate array logic.

It further comprises an electronic memory device 20, advantageously a non-volatile memory device.

Memory device 20 comprises a number of storage sections for various purposes. In particular, it can comprise:
A value store 22 for storing a carrier value of carrier 2, e.g. in units of the carrier's preferred currency. This is the monetary value currently assigned to the carrier. Value store 22 can be read-only, write-once, or read/write, depending on the application and requirements of carrier 2.
An owner store 24 for holding a unique owner identifier of an owner of carrier 24. Owner store 24 is advantageously read/write.
An enable store 25 storing if said carrier is enabled or disabled. Enable store 25 is advantageously read/write.
A key store 26 holding at least one public key identifying equipment authorized to access the carrier. This store is advantageously read-only.

Further, control unit 10 comprises an interface circuit 28, which allows an external device (e.g. a “terminal device” described below) to electronically communicate with control unit 10. Interface circuit 28 is connected to and comprises antenna 14.

Interface circuit 28 can comprise at least one of the following interface types:
A capacitive interface: In this case, antenna 14 is formed by one or more electrodes, which are brought into proximity of the electrodes of the external device in order to establish a capacitive coupling.
An inductive interface, which typically comprises (as shown) a loop antenna that is able to pick up and to emit a varying magnetic field to be used for communication with the external device. This type of interface is e.g. required for implementing an NFC (Near Field Communication) interface.
An RF interface, i.e. a classical radio frequency interface using radio communication. This type of interface is e.g. required for implementing a Bluetooth interface.
An optical interface. In this case, interface circuit 28 is an optical sensor and, optionally, a light emitter, adapted to detect and decode modulated light. For example, data can be transmitted optically from a terminal device to carrier 2 by modulating the light intensity of a display of the terminal device and by holding carrier 2 at a position where interface circuit 28 can detect this modulation.

Advantageously, interface circuit 28 is adapted to receive power from an external device, in particular the terminal device described below, for operating control unit 10. Power can e.g. be transmitted inductively, capacitively or optically.

In particular, interface circuit 28 can be connected to battery 12 in order to recharge it.

In the embodiment of FIG. 1, control unit 10 is arranged laterally adjacent to an optically variable device (OVD) 30. In this context, the term “laterally adjacent” is to be understood as being adjacent in a direction perpendicular to the large surfaces of substrate 4, but there does not necessarily have to be a direct contact between OVD 30 and control unit 10 (i.e. there may be an intermediate layer structure arranged between OVD 30 and control unit 10).

In particular, control unit 10 can be border on only one side to an OVD 30, or it can be arranged between (sandwiched between) two OVDs 30.

In more general terms, control unit 10 is embedded in substrate 4. Advantageously, it can be covered, at least at one side, in particular on both sides, by an OVD 30. Advantageously, the OVD comprises a diffractive structure, in particular a surface hologram and/or a volume hologram 31.

Combining control unit 10 in this manner with an OVD 30 allows to more easily detect if control unit 10 has mechanically been tampered with.

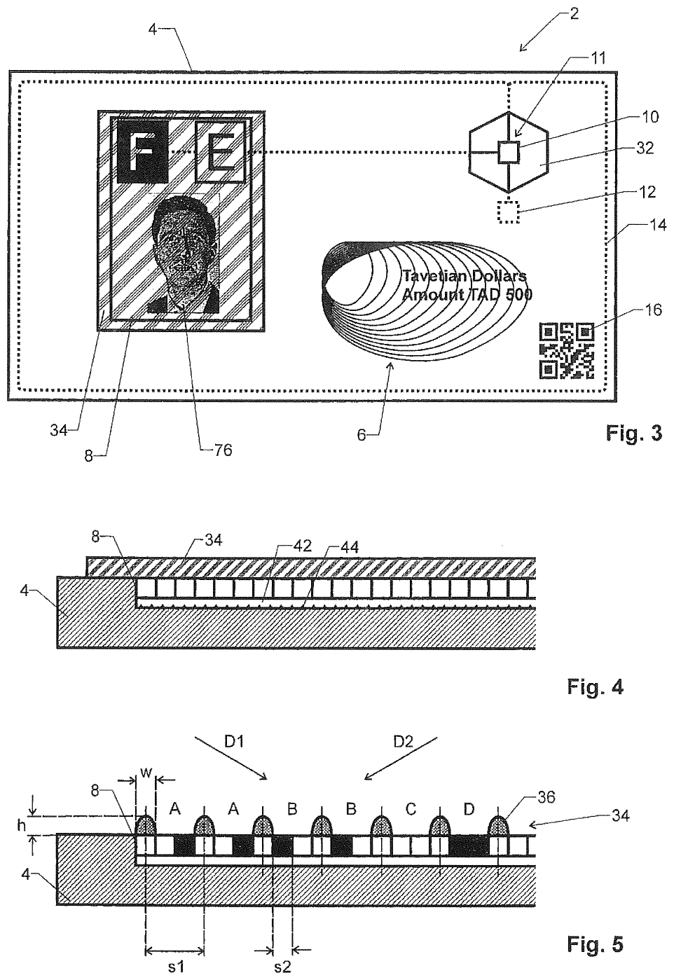

In another embodiment, as shown in FIG. 3, carrier 2 can comprise an at least partially transparent window or half-window 32 arranged in substrate 4. In this case, control unit 10 can be arranged in this window or half-window 32, thus that it is visible. In particular, window 32 is spanned by a transparent or semi-transparent plastic material and control unit 10 is embedded into this plastic material.

In this case, control unit 10 is well visible, which allows the user to easily check for mechanical damage thereof.

The various circuits of carrier 2, such as control circuit 10, memory device 20 and/or interface circuit 28, can e.g. at least in part be implemented as integrated circuits on a semiconductor chip 11.

Display Device:

As mentioned, carrier 2 advantageously comprises a display device

Advantageously, in order to reduce power consumption, display device 8 is a non-light-generating display, i.e. a display without its own light source, even though an illuminated display can be used as well.

In a particularly power conservative embodiment, display device 8 is an e-ink device comprising particles having differently colored sides. These particles can be moved by an electric (and/or magnetic) field to expose the one or the other side to the viewer. In the absence of a field, the particles retain their position. This type of display, which is per se known to the skilled person, allows to operate the device with very lower power consumption.

Even though, as mentioned, display device 8 can consist of single or multiple segments that are not necessarily arranged in a regular pattern, it is advantageously a pixel-based device with a plurality of pixels arranged in a two-dimensional matrix. Control unit 10 is able to control each pixel individually.

Advantageously, control unit 10 is programmed to display, on display device 8, a pattern derived from information stored in memory device 20. In this context, the term “pattern” is to be understood broadly to encompass letters, symbols, images, etc. In particular, control unit 10 can be programmed to display a plurality of differing patterns, in particular more than two differing patterns, on display device 8.

For example, control unit 10 can be programmed to display a pattern derived from value store 22, such as the carrier's value as a series of digits (as shown in FIG. 1). If the carrier can only take one value (or be empty), the pattern can also be a “full” and “empty” type of display, such as illustrated with the letters F and E in FIG. 3.

In another example, control unit 10 can be programmed to display a pattern derived from the data in owner store 24, and/or in enable store 25.

Generally, control unit 10 is advantageously adapted to display, on display device 12, a status of the carrier.

Advantageously, display device 12 is a multi-color display that is able to display patterns of differing colors. In this case, control unit 10 can be programmed to set the color of the display device as a function of the carrier's value stored in value store 22. This allows using different color schemes depending on the carrier's value, as it is known for conventional banknotes where the notes have different colors depending on their denomination.

As described in more detail below, display device 8 is used to display important information about the status of carrier 2. Hence, a need arises to make display device 8 less prone to tampering. For example, a counterfeiter might try to overprint display device 8 with certain (misguiding) information. In the following, with references to FIGS. 4-7, some measures are described to fight such counterfeiting.

In particular, these measures include providing an authentication device 34 for verifying the authenticity of the status shown by display device 8.

In the embodiment of FIGS. 1 and 3, this authentication device 34 is positioned to optically interact with display device 8.

Specifically, in the shown embodiment, authentication device 8 is arranged over and affixed to at least part of display device 8, e.g. by adhesion (such as gluing) or by means of printing techniques. Hence, display device 8 can be viewed through authentication device 34, thereby making it more difficult to fake the information on display device 8.

For example, as shown in FIG. 4, authentication device 34 can be an optically variable device, such as a diffractive structure, in particular a surface hologram and/or a volume hologram, which is arranged (or can be arranged) over display device 8. This diffractive structure generates a diffractive image overlaying the display, and it is difficult to fake by means of simple printing techniques.

In general, authentication device 34 is advantageously an at least partially transparent structure arranged over display device 8. Advantageously, this structure is affixed to display device 8, and/or it is refractive and/or diffractive and/or partially absorbing.

FIG. 5 shows an embodiment of such a partially transparent structure comprising a series of raised features 36. Such features can generate optical effects depending on the observer's viewing angle.

Advantageously, the raised features 36 comprise a lateral size w and/or a height h and/or spacing s1 between 0.2 and 5 μm. In this case, the raised features 36 are comparable to visible wavelengths and therefore able to generate diffractive tilting effects.

In another advantageous embodiment, the raised features comprise a lateral size w and/or a height h and/or spacing s1 between 5 μm and 2 mm. In this case, the raised features are apt to generate shadowing effects that make the image displayed in display device 8 depend on the user's viewing angle.

In this context, the term “lateral size” w relates to the extension of the features 36 parallel to the surface of substrate 4, while the term “height” h relates to the extension of the features 36 perpendicularly to the surface of substrate 4.

In a particularly advantageous embodiment, this partially transparent structure comprises a printed ink structure printed onto said display, i.e. it is applied by means of printing an ink onto substrate 4. In particular, an intaglio structure can be used, i.e. an ink structure applied by intaglio printing, or inkjet structure, i.e. a structure applied by inkjet printing. Intaglio printing and inkjet printing are particularly suited for generating raised structures on a substrate.

In another embodiment, authentication device 34 comprises at least one of the following structures: surface gratings, lenses, blaze gratings, Fresnel lenses.

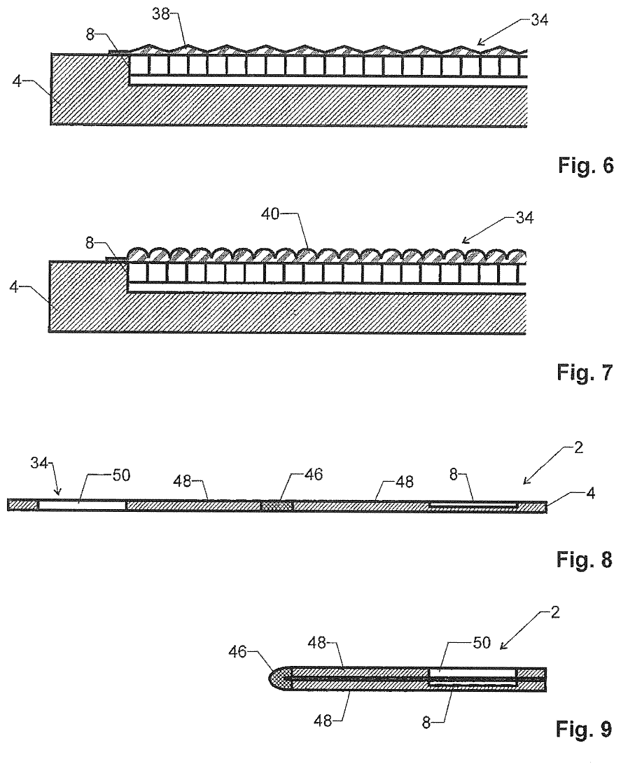

For example, FIG. 6 shows a blaze grating structure, where an at least partially transparent layer 38 forming prism-shaped diffractive or refractive structures is applied over display device 8. In such a structure, the image that can be seen on display device 8 depends strongly on the observer's viewing angle.

In another example, FIG. 7 shows series of small lenses 40 arranged over display device 8. This again leads to an image that depends strongly on the observer's viewing angle.

Structures of the type shown in FIGS. 6 and 7 can e.g. be created by laminating a pre-structured thin film onto substrate 4, or by embossing a thin film that is already applied to display device 8.

In a particularly advantageous embodiment, the at least partially transparent structure of authentication device 34 is repetitive and has, as shown in FIG. 5, a structure spacing s1 that is substantially equal to an integer number multiple of the pixel spacing s2 of display device 8. This allows to generate displayed images that are particularly easy to verify in that, depending on the observer's viewing angle, only a specific, well-defined subset of display pixels can be seen.

For example, in the embodiment of FIG. 5, the structure spacing s1 is substantially three times the pixel spacing s2. Further, the lateral size w of the structures is advantageously at most equal to a pixel spacing s2. Hence, the structures 36 can be positioned to cover each third pixel, with two pixels visible in each gap between them. Depending on which of the visible pixels is black or white, very different visual effects are generated.

In the example of FIG. 5, from viewing direction D1, the gaps A and D will appear black while B and C appear white. From viewing direction D2, the gaps B and D are black while A and C appear white.

In this context, the expression “a structure spacing s1 substantially equal to an integer number multiple of the pixel spacing s2” is understood to be such that there is an integer number n for which the following relation holds true:

|s1−n·s2|<0.1·s2

In other words, the mismatch between the grating and pixel spacings is no more than 10% of the pixel spacing.

If the mismatch is not exactly zero (such as shown in FIGS. 6 and 7), interference effects (Moiré effects) can be generated between authentication device 34 and display device 8.

It may be desired to illuminate display device 8. In this case, it can be advantageous for carrier 2 to comprise an optical waveguide 42 for carrying light to display device 8 (this is shown, by way of example, in FIG. 4, even though this technology can be incorporated in any of the displays shown here). Waveguide 42 can be arranged above or below display device 8.

Carrier 2 can comprise its own light source for coupling light into optical waveguide 42, or an external light source can be used for this purpose.

Advantageously, waveguide 42 comprises a coupler 44, adjacent to display device 8, for coupling out light from the waveguide. For example, such a coupler 44 can be implemented by means of a surface grating formed in waveguide 44.

Yet another example for an authentication device 34 is shown in FIGS. 8 and 9. In this embodiment, authentication device 34 is arranged at a distance from display device 8 and can be made to overlay with display device 8

For this purpose, authentication device 34 is advantageously reversibly movable in respect to display device 8. In the embodiment shown, this is achieved by making substrate 4 foldable in at least one folding region 46. Advantageously, this foldable region 46 is arranged between two rigid regions 48 (with the term “rigid” to be understand as the rigid regions 48 being more rigid that the foldable region 46).

Foldable region 46 may e.g. be made from a plastic web that is more flexible than the rigid regions 48, e.g. by using a different material or a different thickness. Alternatively, foldable region 46 may be of another material, such as a textile or paper.

Foldable region 46 is arranged midway between display device 8 and authentication device 34 such that, when folding substrate 4 along foldable region 46, authentication device 34 can be brought to overlap with—and, advantageously, to rest against—display device 8, as it is shown in FIG. 9.

In an advantageous embodiment, substrate 4 is, at the region of authentication device 34, at least semi-transparent, such that display device 8 can be seen through authentication device 34 as the two items are overlaid.

Authentication device 34 can e.g. comprise periodic structures that generate interference patterns with an image on display device 8.

Advantageously, authentication device 34 comprises a polarizer 50 arranged in a window of substrate 4, while display device 8 has anisotropic optical properties. For example, display device 8 can be a nematic twisted LCD display with backside reflector that is able, depending on its state, to reflect light with unchanged or with 90° rotated polarization. The pattern on display device 8 is only visible when overlaid with polarizer 50.

Alternatively, display device 8 can change the polarization state of the light as a function of its wavelength. In that case, holding polarizer 50 against it can generate a color effect and colors can change depending on the rotational position of polarizer 50 in respect to display device 8.

In more general terms, display device 8 can be such that at least part of the information displayed therein becomes visible only and/or changes color when authentication device 34 is overlaid with the display device 8.

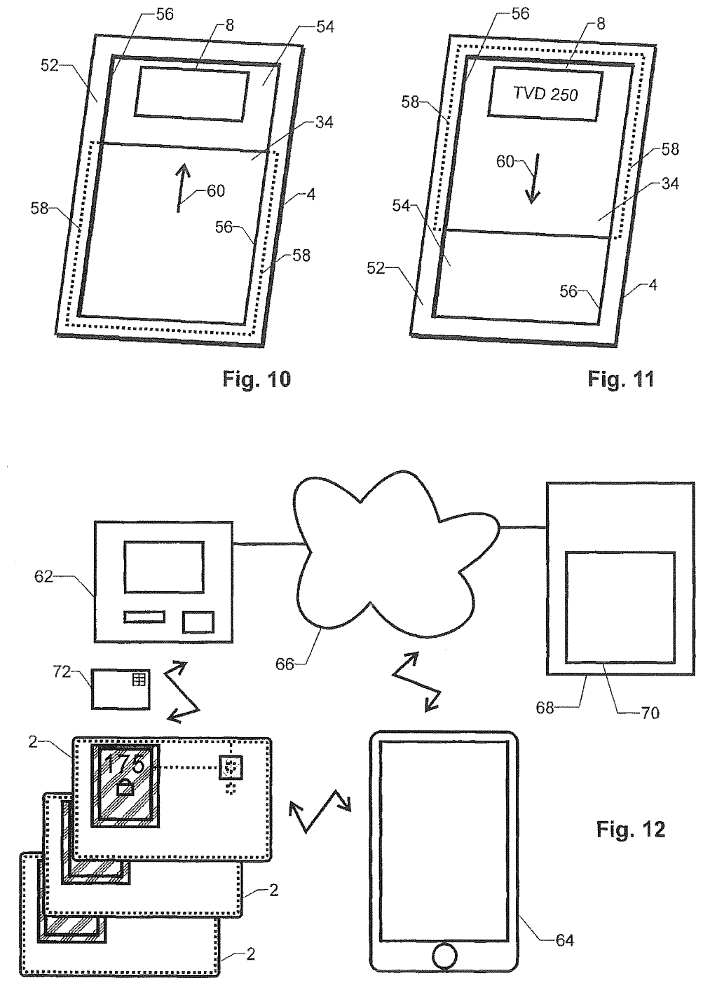

FIGS. 10 and 11 show yet a further embodiment of a carrier, this one with an authentication device 34 that is movably attached to substrate 4.

In the particular embodiment, authentication device 34 is slideably attached to substrate 4. To this end, substrate 4 comprises, by way of example, a frame 52 surrounding a recessed area 54. At least two opposite edges of frame 52 facing recessed area 54 form grooves 56. Authentication device 34 is a plate nesting in recessed area 54, with two opposite edges 58 extending into the grooves 56.

Hence, authentication device 34 can move from a first position (FIG. 10) to a second position (FIG. 11) along the direction of arrows 80.

Advantageously, display device 8 is located such that it is not covered by authentication device 34 in its first position (FIG. 10), but it is covered by authentication device 34 in its second position (FIG. 11).

Authentication device 34 and display device 8 are selected such that the appearance of the information of display device 8 varies depending on the mutual position of authentication device 34 and display device 8. For example:
As in the embodiment of FIGS. 8 and 9, authentication device 34 can comprise an optical polarizer, and display device 8 can have anisotropic optical properties. When authentication device 34 does not cover display device 34, display device 34 appears blank or has a first color. When authentication device 34 covers display device 34, a displayed pattern will become visible or the displayed pattern will change color.
Authentication device 34 can comprise first periodic structures and display device 8 can be operated to display second periodic structures, with the two structures having (within 10%) the same spacing. Hence, when moving authentication device 34 in respect to display device 8, moving interference (Moiré) patterns will appear.

In the embodiment of FIGS. 10 and 11, authentication device 34 is slideable in a linear motion parallel to a surface of substrate 4.

Alternatively, authentication device 34 may also be pivotal or rotatable about an axis perpendicular to a surface of substrate 4, or about an axis parallel to a surface of substrate 4.

Payment Infrastructure:

Carrier 2 is used as a transferrable value token in a payment infrastructure as shown in FIG. 12. In in this section, we describe the set-up of this infrastructure. Details regarding its operation will follow in the next section.

The payment infrastructure encompasses a plurality of the carriers 2 as described above. They are usually in the possession of the individual users of the system.

In addition, the infrastructure comprises a plurality of terminal devices 62, 64 that are able to communicate with the carriers 2 through their interface circuits 28.

Advantageously, at least some of the terminal devices are mobile devices 64, in particular smartphones, which makes them are readily available to the users of the infrastructure.

Some other of the terminal devices may be ATM machines or POS (point of sale) machines 62, at least some of which are typically non-mobile.

The terminal devices 62, 64 are connected to a large area network 66, in particular the internet.

The infrastructure further comprises at least one server device 68. Typically, there are several such server devices 68.

Server device 68 is remote from the terminal devices 62, 64 and connected to them through network 66. Thus, server device 68 is able to communicate with the terminal devices 62, 64.

Server device 68 comprises an account store 70 holding a plurality of accounts with an account value attributed to each account. These are database records describing monetary accounts of the users of the infrastructure.

Typically, server device 68 is operated by a bank or a payment service provider.

Operation:

The infrastructure of FIG. 12 as well as the carriers 2 described above are used for transferring monetary values between users. In the following, we describe some methods, functions and protocols to do so.

In principle, the carriers 2 can be used in the same manner as banknotes, i.e. they represent a monetary value that can be transferred between the users by physically transferring the carriers.

However, depending on the details of their design, the carriers 2 can provide additional functions that go beyond the functionality of conventional banknotes.

As mentioned, each carrier 2 comprises a value store 22 that stores the monetary value assigned to the carrier.

Advantageously, the value store can be changed by means of one of the terminal devices 62, 64.

Further, as mentioned, memory device 20 can store additional information. Advantageously, at least some of this information can also be changed by the terminal devices 62, 64.

Also, the terminal devices 62, 64 can typically be used to read information from memory device 20.

Any of these operations comprise the step of establishing a communication between one of the terminal devices 62, 64 and one of the carriers 2.

For security reasons, at least some access to the carriers 2 through interface circuit 28 should be limited to authorized terminal devices 62, 64 only.

Hence, for at least some operations where a given one of the terminal devices 62, 64 communicates with a given one of the carriers 2, the following steps are used:

1. The terminal device 62, 64 sends a query to the carrier 2. This query can e.g. describe a request to access (i.e. to read and/or write) a certain information in carrier 2.

2. In response to the query, carrier 2 sends a challenge to terminal device 62, 64. Advantageously, this challenge is a pseudo-random challenge, i.e. it comprises data that is, in practice, unpredictable. Alternatively, the challenge comprises at least data that is hard to predict.

3. Terminal device 62, 64 generates a response using the challenge and a secret key. To do so, it can apply asymmetric cryptography. For example, terminal device 62 can digitally sign the challenge using its secret key.

4. Terminal device 62, 64 sends the response to carrier 2.

5. Using the value in key store 26, carrier 2 verifies the response, e.g. by checking the authenticity of the mentioned signature.

For these steps, the terminal devices 62, 64 comprise a key store that holds a secret key shared by all terminal devices. Alternatively, step 3 is carried out in server device 68 upon request by one of the terminal devices.

The public key stored in key store 26 of carrier 2 is advantageously paired with the secret key used in step 3.

The above protocol allows a carrier 2 to verify the authenticity of a terminal device 62, 64.

The same protocol, vice versa, can also be used in the terminal devices 62, 64 in order to verify that a given carrier is a genuine carrier.

Hence, in more general terms, the invention advantageously refers to a method for communication between a first and a second device. The method comprises the following steps of exchange between the first and the second device:
Sending, from the first device, a challenge to the second device: This challenge is advantageously a pseudo-random challenge;
Generating a response using said challenge and a secret key using asymmetric cryptography: Advantageously, this step is carried out in said second device, or, if the second device is one of the terminal devices 62, 64, the second step can also be carried out in server device 68;
Sending, from said second device, said response to said first device;
Verifying, in said first device, said response using said public key and using asymmetric cryptography.

The first and second devices are both selected from the group of carriers 2 and terminal devices 62, 64, but at least one, in particular exactly one, of the first and second devices is one of the carriers 2.

Once that the authenticity of the partners in such a communication has been established, the terminal devices 62, 64 can read and/or write at least some of the data in carrier 2.

A more refined scheme for authorization and authentication is described in the following section, “ownership control”.

The carriers 2, or at least some of them, can have a fixed value assigned to them. In other words, the value of a given carrier is, in that case, either its predefined, fixed value or zero.

In that case, this fixed value may also be printed onto the carrier as part of text and artwork 6, as shown in FIG. 3. The value of the carrier can, in this case, optionally be set to zero, e.g. by using enable store 25 in order to disable the carrier. This is advantageously displayed in display device 8, e.g. using the “F” and “E” marks (for “full” and “empty”) shown in FIG. 3.

In another embodiment, at least some of the carriers 2 may have variable value, i.e. value store 22 is adapted and structured to assign at least three different carrier values to the carrier. In particular, the number of different carrier values can be much larger than three. In this case, the current carrier value is advantageously displayed in human-readable manner in display device 8, such as shown in FIG. 1 as the number “175”.

For security reasons, or for commercial reasons, control unit 10 can be programmed to limit the maximum carrier value that can be assigned to the carrier.

Advantageously, there can be different carriers having different maximum carrier values assigned to them. In other words, the invention also relates to a set of carriers of this type having different maximum carrier values.

In this case, advantageously, the carriers having different maximum carrier values are visually different such that the user can distinguish between them. Such different carrier values can e.g. be printed as part of text and artwork 6, as illustrated in FIG. 1.

This allows e.g. to treat the carriers of different maximum carrier value differently, e.g. in a flexible pricing or depot scheme where carriers with a large maximum carrier value are priced more expensively than carriers with smaller maximum carrier values.

Advantageously, carrier 2 carries a visually detectable mark, such as mark 16 mentioned above, encoding an identifier, and control unit 10 is programmed to be unlocked, at least for certain types of access, by means of this identifier, i.e. a terminal device 62, 64 has to send this identifier over interface circuit 28 to the carrier in order to gain access. This allows to make sure that the terminal device, or its user, has visual access to carrier 2 and eliminates the risk of it being accessed while e.g. stored in a wallet without its owner being aware of the access.

For example, mark 16 can comprise a PIN code as a series of digits that the user has to enter in the terminal device in order to gain access.

Mark 16 can also comprise a bar code or QR code or another code optimized for machine reading and the terminal device can be equipped with a camera to scan mark 16. As mentioned, carrier 2 can comprise an enable store 25 storing if the carrier is enabled or disabled. When carrier 2 is disabled, it is invalid as a means of payment.

Advantageously, control unit 10 is programmed to display, on display device 8, a token indicative of said carrier being enabled or disabled. For example, display device 8 can be set to display “void” or “disabled” if the carrier in its disabled state.

Transferring funds:

The infrastructure of FIG. 8 can be used to transfer funds between the accounts stored in server device 68 and the carriers 2. In order to execute a transfer from a carrier 2 to one of the accounts, the terminal devices 62, 64 and the carriers 2 are programmed to decrease the carrier value of a given carrier 2 and to increase the account value of a given account. Similarly, in order to execute a transfer from an account to one of the carriers 2, the terminal devices 62, 64 and the carriers 2 are programmed to decrease the account value of a given account and to increase the carrier value of a given carrier 2.

In more general terms, the server device 68, the terminal devices 62, 64, and the carriers 2 are adapted and structured to transfer values by decreasing one of a pair of said carrier values and said account values and increasing another of said pair of said carrier values and said account values.

In order to execute such a transfer, the following steps can be used:

1. Identifying a target account among the accounts in account store 70. This is the account to be used for the transfer.

2. Establishing communication between one of the terminal devices 62, 64 and one of the carriers 2, and

3. Transferring the value between the target account and the one carrier 2.

This is advantageously combined with a test that the terminal device is operated by a user authorized to interact with the target account. This can e.g. be achieved by the following steps:

1. Receiving passcode data or biometric data by means of one of the terminal devices 62, 64.

2. Verifying the passcode data or biometric data in order to check if the user is authorized to operate the terminal device and/or to access the target account.

3. Rejecting execution (i.e. not carrying out execution) of the above step of transferring the value if the step of verifying the passcode data or biometric data fails.

Further, two-factor verification using an “identification token” (such as an ATM card) can be used. Such an identification token is shown in FIG. 12 under reference number 72. In this case, the method comprises the steps of

1. Establishing communication between one of the terminal devices 62, 64 and an identification token 72. In particular, the identification token can be an ATM card and the terminal device is an ATM machine 62.

2. Reading, from said identification token 62, data indicative of said target account. In the example of an ATM card and an ATM machine 62, the ATM card usually encodes a target account.

Step 1 can include a verification step, such at the entry of a PIN into the terminal device in order to unlock the identification token 72 for access.

To transfer funds between two carriers 2, the funds can first be transferred from a first carrier to an account and then from this account to a second carrier.

Alternatively, the terminal devices 62, 64 may also be equipped to directly transfer funds between a first and a second one of the carriers 2. Hence, the terminal devices 62, 64 and the carriers 2 can be adapted and structured to transfer values directly between a first and a second one of said carriers by decreasing the carrier value of the first carrier and increasing the carrier value of the second carrier.

In this case, advantageously, the terminal devices 62, 64 are programmed to open communication sessions with the first and the second carrier in parallel and to close said communication sessions only after transferring the value. Advantageously, the changes of the carrier value are only updated in carrier store 22 upon closing the sessions. This allows to avoid partially completed transfers,

In yet another advantageous embodiment, the carriers 2 can be equipped to directly transfer funds between each other. Such a transfer provides optimum privacy,

To do so, the interface circuits 28 of the carriers 2 are able to directly communicate with each other and the control units 10 are structured to transfer values between a first and a second one of the carriers by

1. Mutually authenticating the first and second carrier: This can e.g. be implemented by means of a challenge-response process as described above, where each carrier 2 uses a secret key shared by all carriers.

2. Decreasing the carrier value in the first carrier and increasing the carrier value in the second carrier.

The amount of currency transferred in this manner can e.g. be
The full amount of a carrier. In this case, no special operations are required by the user(s) to define the amount.
A default amount. In this case, again, no special operations are required by the user(s) to define the amount.
An amount defined by the user(s). For example, this amount can first be communicated through one of the terminal devices 62, 64 to the first card, whereupon the cards are brought into communicating contact to effect the transfer.

The power from the communication between the two carriers can be provided by battery 12, and/or the two carriers can be brought into the powering range of one of the terminal devices 62, 64 to receive power therefrom.

In order to designate the carrier that is to be decreased in value (i.e. the “first carrier” in the steps above), at least one of the following means can be used:
If an external device, such as one of the terminal devices 62, 64, is used, in particular for powering the carriers 2, the first and second carrier can be selected by interaction with the external device. E.g. the external device can prompt the user to identify the first carrier by placing it at a certain position in respect to the external device.
The roles of first and second carrier can be defined by the mutual position of the two carriers. For example, each carrier can have a first end section (e.g. marked by a printed outward-facing arrow 80 as shown in FIG. 1) and a second end section (e.g. marked by a printed inward-facing arrow 82 as shown in FIG. 1). In order to effect a transfer of funds, the respective end sections of the two carriers are overlaid, and the funds are then transferred from the carrier whose first end section is overlaid with the second end section of the other carrier, Suitable detectors 84 are provided on the carriers to detect such a mutual position. These may e.g. be capacitive detectors, and/or they may form part of interface circuit 28 and its antenna.

Hence, more generally, each carrier 2 can comprise at least one detector 84 that is able to distinguish between at least two different mutual positions in respect to another carrier of its kind. This allows to define a type of interaction to be carried out by the two carriers. Advantageously, in both these positions, its interface circuit is able to communicate with the interface circuit of the other carrier.

Ownership Control:

In the examples shown so far, possession of a carrier 2 provides full access to the monetary value it holds, just like for a banknote.

In an advanced embodiment, carrier 2 offers additional functionality for optionally assigning it to an owner. In this case, if carrier 2 is assigned to an owner, certain privileged operations, such as certain privileged change requests for modifying the data in memory device 20, are restricted to the owner.

The current owner of a carrier can be stored in owner store 24, e.g. as a unique identifier, such as the public key of an asymmetric public-private-key-pair of the owner, The private key can e.g. be stored in a mobile terminal device 64 owned by the owner, i.e. they cannot be carried out by an unauthorized third party.

Advantageously, owner store 24 can also be set to an “unowned state” indicative that no specific owner is being assigned to carrier 2.

Control unit 10 can be programmed to display, on display device 8, a token indicative of owner store 24 being in its unowned state or not. This allows users to see if the carrier is freely transferrable. In the embodiment of FIG. 1, this token is represented in the form of a lock 74 showing that the device is in its owned state.

Also, owner store 24 can be of sufficient bit size to hold image data representing the face of the current owner. This image data can be transferred from a terminal device 62, 64 to the carrier upon assigning the carrier to a given owner. For this purpose, terminal device 62, 64 must be adapted to store this image data, too. This is particularly useful if the terminal device 62, 64 is a mobile device 64, such as a smartphone, owned by the owner.

To transfer such image data, the present method of operation advantageously comprises the step of transferring the image data of the face of the owner from one of the terminal devices 62, 64 to one of the carriers 2.

In this case, control unit 10 can be programmed to display this image data on display device 8, such as shown under reference number 76 in the embodiment of FIG. 3. This allows the users of the system to not only verify if a carrier is in its owned state, but also to visually test if a given person is the owner.

In order to test if a privileged operation can be carried out on carrier 2, a testing operation must be implemented by control unit 10. In particular, for at least some operations where a given one of the terminal devices 62, 64 communicates with a given one of the carriers 2, the following steps are executed:

1. Testing, between the terminal device 62, 64 and the carrier 2, that the terminal device is associated with the owner. In this context, “associated with” e.g. expresses that the terminal device stores unique data associated with the owner and/or that the terminal device has successfully received some secret code (password, passcode) or biometric data from the owner.

2. Allowing at least some privileged operations, such as at least some privileged change requests for changing certain values in memory device 20, from this given terminal device only if the testing step has asserted that the terminal device is associated with the owner.

Step 1, i.e. the testing step, can e.g. include at least one of the following steps:

1.1 Sending, from said terminal device 62, 64 to said carrier 2, a unique identifier identifying the current user or owner of the terminal device 62, 64, and comparing, in said carrier 2, if the unique identifier is equal to the owner stored in owner store 24.

1.2 (Alternatively or in addition to step 1.1:) Sending a challenge, in particular a pseudo-random challenge, from carrier 2 to the terminal device 62, 64; generating, in said terminal device 62, 64, a response using said challenge and a secret key using asymmetric cryptography, and sending the response back to the carrier 2; verifying, in said carrier 2, the response using the owner's public key stored in owner store 24.

Step 1.2 can e.g. comprise digitally signing the challenge in terminal device 62, 64 using the secret key and testing the signature in carrier 2 using the public key.

In order to carry out such tests, control unit 10 is advantageously programmed to test if a terminal device 62, 64 connecting to it through interface circuit 28 is associated with the owner whose owner identifier is stored in owner store 24. And it is further programmed to allow the privileged operations, such as at least some privileged change requests for changing state information of carrier 2, only if the test confirms that the terminal device 62, 64 is associated with the owner. (In this case, the term “associated with” is to be understood as mentioned for step 1 above.)

The following is a list of possible “privileged operations” all of some of which can be reserved to terminal devices 62, 64 associated with the carrier's owner:
Changing the carrier value in value store 22: Only the current owner (if one is assigned to the carrier) is allowed to increase or decrease the carrier's value.
Changing the owner store 24: Only the current owner (if one is assigned to the carrier) is allowed to change the owner of a carrier or to set it into an unowned state.
Changing the enable store 25: Only the current owner (if one is assigned to the carrier) and/or another authorized entity, in particular server device 68, is allowed to change the carrier between its enabled or disabled states. For example, owners may want to disable carriers of large value that they do not want to use in the near future, thereby further securing them against theft.

If carrier 2 is in its unowned state, control unit 10 is advantageously programmed to allow the privileged operations without testing for ownership.

In yet another advantageous embodiment, the card can be disabled by changing its enable store 25 by the current owner assigned to the carrier or by anyone having physical access to the card, using any of the terminal devices 62, 64. However, re-enabling the card is only possible at an ATM terminal device 62. This has the advantage that the process of enabling can be supported by the additional security measures an ATM terminal provides. For example, the enabling process can be monitored by a camera of the ATM terminal. This renders it more difficult to abusively force a carrier's owner into unlocking the carrier.

Method of Manufacture:

The details of manufacture of carrier 2 depend on the nature of substrate 4 as well as on the desired features.

If substrate 4 is a plastic card, most of the manufacturing steps are the same as they are used for credit cards.

Display device 8 can e.g. be arranged in a recess in substrate 4.

If an authentication device 34 is to be used in combination with display device 8, manufacturing advantageously comprises the step of applying this authentication device to the carrier.

For example, at least part of the authentication device 34 can be printed onto carrier 2, and in particular onto display device 8. As mentioned above, an advantageous printing technique to be used is intaglio printing if authentication device 34 is using raised structures. Another advantageous printing technique is inkjet printing, which can also be used to apply raised structures.

In another example, the creation of authentication device 34 can comprise the step of embossing or laminating at least part of the authentication device 34 onto said carrier, in particular onto display device 8.

Notes:

The operation of the infrastructure shown in FIG. 12 is controlled by software distributed over the carriers 2, the terminal devices 62, 64, and the server device 68. Thus, the invention also relates to a computer program product comprising instructions that, when the program is executed on the infrastructure, cause the infrastructure to carry out some or all of the steps of the method described above.

As mentioned, server device 68 can carry out special operations on carrier 2 when carrier 2 is connected to it through one of the terminal devices 62, 64. In particular, server device 68 may e.g. disable a carrier 2 by changing its enable store 25 when there are reasons to be believe that the given carrier 2 is abused. For this purpose, server device 68 can e.g. authorize itself in a challenge-response process similar to the one described above.

In the embodiments above, carrier 2 comprises its own battery 12. Alternatively, carrier 2 can be provided without its own battery and be powered only while communicating with one of the terminal devices 62, 64. This simplifies the design of the carrier. This type of (battery-less) carrier is advantageously combined with a display device 8 that only requires power while changing its appearance, such as an e-ink type device.

While there are shown and described presently preferred embodiments of the invention, it is to be distinctly understood that the invention is not limited thereto but may be otherwise variously embodied and practiced within the scope of the following claims.

1. A carrier for representing a monetary value as a means of payment comprising
a substrate,
a control unit mounted to said substrate,
a value store adapted and structured to store a carrier value of said carrier, and
an interface circuit for electronic communication with said control unit,
wherein said carrier further comprises
an owner store for holding a unique owner identifier of an owner of said carrier.

2. The carrier of claim 1 further comprising a display device wherein said control unit is adapted to display, on said display device, a status of said carrier.

3. The carrier of claim 1, wherein said owner store can be set to an unowned state indicative of no specific owner being assigned to said carrier.

4. The carrier of claim 3 further comprising a display device, wherein said control unit is adapted to display, on said display device, a status of said carrier, wherein said control tent is adapted and structured to display, on said display device, a token indicative of said owner store being in said unowned state.

5. The carrier of claim 1, further comprising, in addition to said value store an enable store storing if said carrier is enabled or disabled.

6. The carrier of claim 5, further comprising a display device, wherein said control unit is adapted to display, on said display device, a status of said carrier, wherein said control unit is adapted and structured to display, on said display device, a token indicative of said carrier being enabled or disabled.

7. The carrier of claim 1, wherein said control unit is adapted and structured to test if a terminal device connecting said carrier through said interface circuit is associated with the owner whose owner identifier is stored in said owner store and to allow at least. some privileged operations in particular at least sonic privileged change requests for changing state information of said carrier, only if said test confirms that said terminal device is associated with said owner.

8. The carrier of claim 7, wherein a request to change said value store is one of said privileged operations.

9. The carrier of claim 7, wherein a request to change said owner store is one said privileged operations.

10. The carrier claim 7 further comprising, in addition to said value store, an enable store storing if said carrier is enabled or disabled, wherein a request to change said enable store is one said privileged operations.

11. The carrier of claim 2, wherein said owner store is adapted and structured to hold image data representing a face of said current owner and. wherein said control unit is structured and adapted to display said image data on said display device.

12. A payment infrastructure comprising a plurality of the carriers and a plurality of terminal devices Wherein said terminal devices are adapted and structured to communicate with said carriers through said interface circuits.

13. The payment infrastructure of claim 12, wherein at least some of said terminal devices are mobile devices, in particular smartphones.

14. The payment infrastructure of wherein at least some of said terminal devices are ATM machines and/or POS machines.

15. A method for operating the payment infrastructure of claim 12 comprising the step of establishing a communication between one of said terminal devices and one of said carriers.

16. The method of claim 15, wherein at least some operations where a given one of the terminal devices communicates with a given one of said carriers the method comprises the following steps:
testing, between the terminal device and the carrier, that the terminal device is associated with the owner,
allowing at least some privileged operations, in particular at least some privileged change requests for changing certain values in said carrier, from the given terminal device only if the step of testing has asserted that the terminal device is associated with the owner.

17. The method of claim 16, wherein said step of testing comprises testing that the terminal device has successfully received a secret code or biometric data from said owner.

18. The method of claim 16, wherein said step of testing comprises at least one of the following steps:
sending a challenge, in particular a pseudo-random challenge, from said carrier to the terminal device generating, in said terminal device, a response using said challenge and a secret key using asymmetric cryptography and, sending the response back to the carrier; verifying, in said carrier the response using an owner's public key stored in said carrier.

19. The method of claim 15, comprising the step of transferring image data of a face of said owner from said terminal device to one of said carriers

20. A computer program product comprising instructions that, when the program is executed on infrastructure cause the infrastructure to carry out the steps of the method of claim 16.
